(19) United States
(12) Patent Application Publication
(10) Pub. No.: US 2016/0148315 A1
(43) Pub. Date: May 26, 2016

(54) METHODS AND APPARATUS FOR SHARED OWNERSHIP TRANSACTIONAL ASSET BACKED SECURITY

(71) Applicant: William D. Meadow, Jacksonville, FL (US)

(72) Inventor: William D. Meadow, Jacksonville, FL (US)

(21) Appl. No.: 14/950,513

(22) Filed: Nov. 24, 2015

Related U.S. Application Data
(60) Provisional application No. 62/083,856, filed on Nov. 24, 2014.

(51) Int. Cl. G06Q 40/06; G06Q 50/18

(52) U.S. Cl. CPC G06Q 40/06; G06Q 50/18

(57) ABSTRACT

The present invention provides apparatus and methods for providing investment in a legal entity by a customer of the legal entity. Investment is correlated with one or both of assets managed by the legal entity and assets transferred to the customer based upon investment in the legal entity. In addition, one or more services may be provided to the customer based upon investment in the legal entity.

### CROSS-REFERENCE TO RELATED APPLICATION

This application claims priority to U.S. Provisional Patent Application Ser. No. 62/083,856 filed Nov. 24, 2014, and titled “METHODS AND APPARATUS FOR SHARED OWNERSHIP TRANSACTIONAL ASSET BACKED SECURITY”, the entire contents of which are incorporated herein by reference.

### TECHNICAL FIELD OF THE INVENTION

The technical field relates to automated apparatus for shared ownership and management of assets. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of wide area network communications facilitating the generation and trading of hybrid asset backed securities.

### BACKGROUND

Securitization is well known in the financial services industry. In general, securitization is associated with a process by which financial instruments such as: loans, consumer installment contracts, leases, receivables, and other relatively illiquid assets with common features are packaged into interest-bearing securities with marketable investment characteristics. Associated processes allow financial institutions to convert claims held on balance sheets into marketable securities.

Federal securities law of the United States provides generally that a security includes an ownership interest in a debt or equity, or some combination thereof, of a business entity or special purpose entity (SPE). Such ownership interest does not include an obligation or right to participate in any business or management activity of said firm or SPE. As interpreted in law, the definition of “security” may include investment in contracts as well as stock warrants and other rights to subscribe to or purchase any of several types of securities from a firm or SPE.

More recently, the financial industry has informally expanded the concept of a security to include other types of exchange-tradable interests in property, including Asset Backed Securities (BS) and other so-called derivative securities such as options and futures. Such financial instruments are regarded as securities for some purposes by investment regulators and financial industry professionals. Warrants allow an issuing firm to raise investment funds, but do not associate an investment with specific assets of an entity.

None of the models or embodiments of prior types of securitized assets provide for both ownership of specified assets and use of such assets.

### SUMMARY

Accordingly, the present invention provides apparatus and methods for providing investment in a RELE by a customer or subscriber, a shareholder or a participant of the legal RELE. Investment is correlated with one or both of assets managed by the legal entity and assets transferred to the customer based upon investment in the RELE. In addition, one or more services may be provided to the customer based upon investment in the legal entity.

Generally, this invention provides for investment by a Customer in a RELE and ownership rights in securitized assets managed by an entity, as well as defined rights to use such assets. In some embodiments, proprietary rights and physical possession of assets may be transferred to a customer based upon investment in the entity. In one aspect, the present invention may include the creation of a “Recognized Legal Entity” RELE such as a Mutual, Partnership, Corporation, Limited Liability Company (LLC) or other entity recognized by a global governing authority wherein a Defined Set of Assets owned or controlled by the RELE can be “Associated” according to individual “Customer” investors who will own their “CUstomer PRoprietary ASsets” CUPRAS while at the same time the customer will have rights to use the COmmon ASsets COAS. Association may be accomplished, for example via a database linking data to an identified asset, descriptor, tag or label, such as a serial number or a user ID. For example, a person may Customer/Investor may own an interest in a power plant utility and the COASs may include the power plant while the CUPRAS will include one or more utility poles, small power sources (like a Photovoltaic Array) and transmitters located in proximity to the Customer/Investor's home.

Embodiments include a computer server to implement the above methods via executable software stored on the server. If desired, the executable software may be executed on demand via the network access device over a communications network. A network access device will typically be an electronic device such as a computer or a wireless computing device, which may include one or more of wireless, mobile and cellular linked tablets, smart phones and flat panel digital or projection display devices. Devices may conform to the transmission control protocol/internet protocol, cellular protocol or other communication protocol.

Additionally the present invention may include a WEB interface for accessing the executable software stored on the server storage medium, or a method of interacting with a graphical user interface so as to facilitate a financial investment utilizing the above methodologies.

Still other embodiments include computer executable program code residing on a computer-readable medium or a computer data signal embodied in a digital data stream.

The details of one or more embodiments of the invention are set forth in the accompanying drawings and the description below. Implementations may provide advantages such as a right of first refusal to additional assets or services or preferred access to an asset, higher priority to receive benefits from an asset offered by a RELE. Other features, objects, and advantages of the invention will be apparent from the description, the drawings and the claims.

### DESCRIPTION OF THE DRAWINGS

FIGS. 1A-1B illustrate block diagrams of components that may be utilized to implement the present invention.

FIG. 2A-2B illustrate exemplary flows of method steps that may be used in some implementations of the present invention.

FIG. 3 illustrates a network embodiment of the present invention.

FIG. 4 illustrates apparatus that may be used to implement some embodiments of the present invention.

### DETAILED DESCRIPTION

The present invention includes an automated apparatus and method steps performed by such apparatus for defining and trading interests, such as equity interests, in one or more legal entities wherein customer investors of the legal entity own assets utilized in conjunction with services provided by the legal entity for the customer investors.

The present invention provides automated apparatus that enables users to own CURPAS while enjoying low cost benefits of having the CUPRAS associated with one or more COAS. Today, an ABS limits Customer flexibility and freedom of transferring ownership rights in their assets. In some embodiments, the present invention provides for apparatus and systems enabling a Customer to make an investment in RELE and in return for the investment in the RELE receive an equity interest in assets owned by the RELE, as well as have ownership of identified assets (CUPRAS and COAS) transferred to the Customer, wherein the assets may be used in conjunction with services provided to the Customer by the RELE,

Glossary:

Asset Backed Security (ABS) as used herein means a financial security backed by a loan, lease or receivables against assets other than real estate and mortgage-backed securities.

Commonly Owned Asset (COAS) as used herein means assets that are owned according to an ownership interest in a RELE and available for use by two or more Customers.

Customer Capital as used herein shall mean a funding mechanism based upon a customer's right to fund growth of a RELE.

Customer Capital Call: This may be required for a Customer to maintain their CUPRAS in a manner that allows then to properly work when there is an upgrade to the COAS.

Customer Proprietary Assets (CUPRAS) as used herein means an asset owned by a Customer that may be used in conjunction with Services provided by a RELE. A CUPRA may also be used in combination with a COAS in conjunction with a service provided by a RELE.

Defined Set of Assets as used herein refers to CUPRAS plus LOAS.

Hybrid Asset Backed Security (HABS), as used herein means a financial instrument that includes a security interest in a RELE in combination with one or more services provided by the RELE in conjunction with an asset provided by the RELE in return for an investment in the RELE.

“Mutual Company” as used herein means a private company whose ownership base is comprised of its customers of a product and/r service. As its customers are also its owners, the mutual company's customers are entitled to receive profits or income generated by the mutual company.

Nearby Asset, as used herein shall mean an asset in proximity to a Customer that may be used in conjunction with a service provided by a RELE.

Operational Facility (OPFA) as used herein shall mean the combined assets of a RELE that is used to create and deliver products and services to a group of customers who own CUPRAS and COAS.

Recognized Legal Entity (RELE) as used herein means a legal entity recognized by a governing authority having jurisdiction over the entity. Examples of RELEs include, by way of non-limiting example: a Mutual, Partnership, Corporation, and Limited Liability Company.

RELE Services as used herein means a service provided to a Customer in conjunction with CURPAS and COASs.

RELEA Systems as used herein means a RELE Administration System that is an automated apparatus for performing the functions and method steps associated with managing Customer ownership interests and services provided.

Unit of RELE, a used herein means an equity share, access right, or other ownership interest in a RELE, examples of a Recognized Unit of RELE include, by way of non-limiting example, a share of a corporation, a Unit of an LLC, or a Percentage of a Partnership, or a registered subscription that provides access to a COAS.

Security Interest, as used herein, shall mean a legal claim on collateral that has been pledged, usually to obtain a loan. The borrower provides the lender with a security interest in certain assets that can be repossessed if the borrower 1) stops making loan payments or 2) performs or fails to perform some specified action or 3) makes a prohibited action or 4) fails to obtain written approval for some specified action in a particular timeframe. The lender may then take ownership of, and sell repossessed collateral to pay off the loan and any accrued interest and share in remaining proceeds. A transaction in which a security interest is granted is called a secured transaction. The Uniform Commercial Code specifies that the three requirements for a security interest to be legally valid are (1) the security interest is given a value, (2) the borrower owns the collateral and (3) the borrower has signed the security agreement. If the business stopped paying its loan due to bankruptcy, its secured lenders would have precedence over the business's unsecured lenders in making claims on the business's assets.

“SPE” or Special Purpose Entity as used herein means a company with an asset/liability structure and legal status that makes its obligations secure even if a parent company to the SPE goes bankrupt. A SPE is often a subsidiary of a parent company. In some embodiments, a SPE may be used to manage an ABS.

Assets that may be securitized include, by way of example, but not limited to; Fixed-Income Assets; tangible assets, such as equipment; real assets. Fixed-income assets may be viewed as financial obligations characterized by the identity of an obligor and one or more payments to be transferred from the obligor to an asset holder on or before a corresponding specified date. Typically, recourse is provided to the asset holder in event of payment default to specified property rights of the obligor that are intended when the obligation is created to be comparable in value to the obligation value during the life of the obligation. The obligation is discharged once all payments have been made as specified or, in event of default, once the default recourse has been resolved.

A Tangible Asset may include property that has physical form and substance and that which may be felt or touched, and is necessarily corporeal. The expressions tangible asset and tangible property may be considered generally equivalent in this discussion. Tangible assets may be grouped according to various broad physical attributes: real property or personal property; durable, storable or perishable; consumable, recyclable or reusable; commodity or distinctive, characteristics of consumable, recyclable, and unencumbered reusable tangible assets.

Real Assets may be considered as real property or personal property. Generally, a real asset can be a tangible asset. A real asset may be deeded. Commercial real estate, residential real estate and farmland are examples of real assets, and there are others. Property rights associated with a deeded asset can be conveyed by one or more deeds.

A RELE may be viewed as a business organization, which are distinct from tangible assets that may be owned by the RELE. The assets of the RELE extend beyond tangible assets to include intangible sources of value such as organizational structure, intellectual property, client relationships, and the business experience and proprietary expertise of its skilled personnel.

Exchange Traded Fund (ETF) as used herein, an exchange-traded fund (ETF) includes an investment fund traded on stock exchanges, much like stocks. An ETF holds similar assets including RELEA, and trades close to its net asset value over the course of the trading day. ETFs may be attractive as investments because of their low costs, tax efficiency, and stock-like features. ETFs are the most popular type of exchange-traded products.

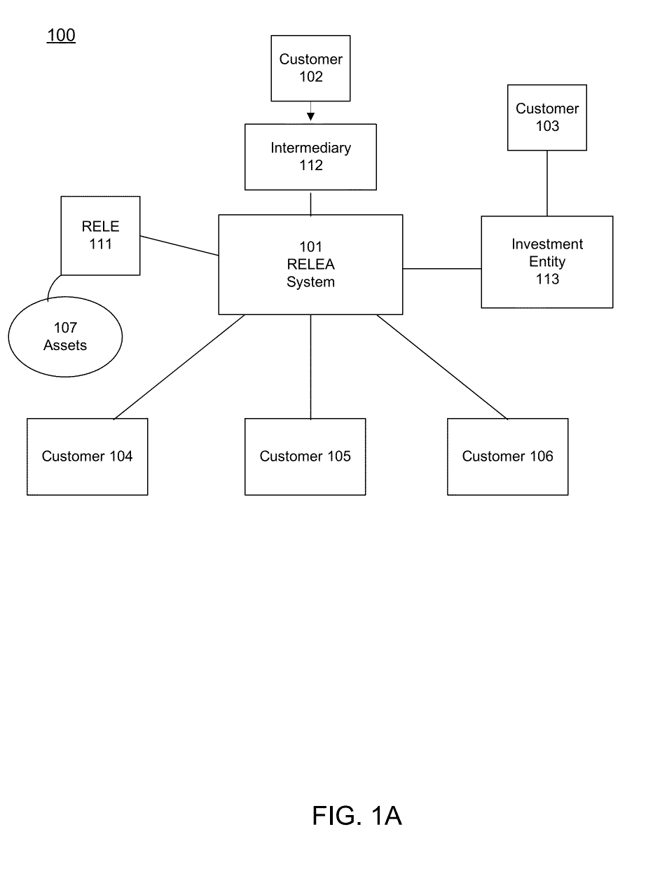

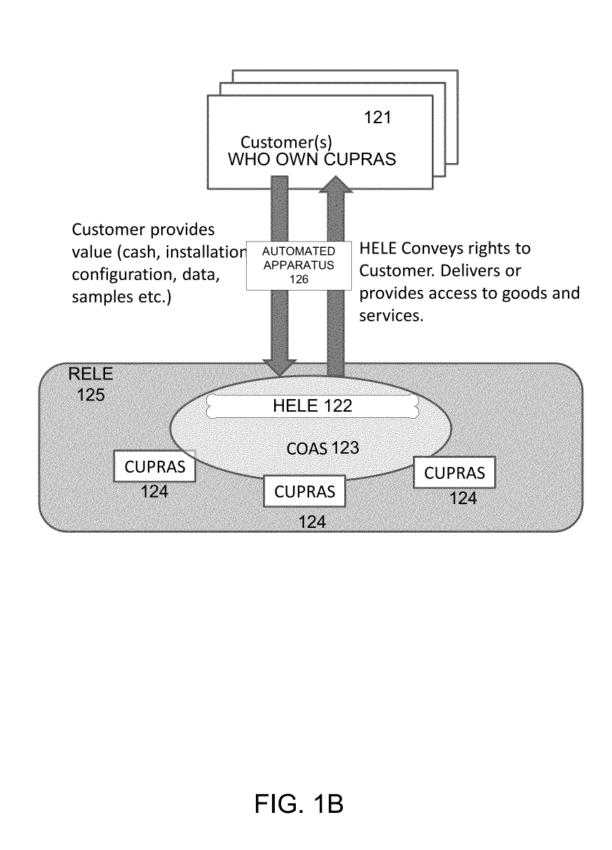

Referring now to FIG. 1A, a block diagram 100 is illustrated representing major components involved in the present invention for investment in one or more RELEs and modeling a RELE SPE according to a RELEA service supported by the RELE and/or RELE SPE to a Customer. A RELE Administration System (“RELEA System”) 101 may receive stated objectives of a RELE and model expected results from investment in a specific RELE or set group of RELEs. In some embodiments, the RELEA System may also receive Service needs of a Customer and model proposed provision of Services to the Customer.

In another aspect, the RELEA System 101 may also make a determination as to whether a Customer's investment is suited to meet one or more objectives of the RELE Customer/investor 102-106. A RELE Customer's 102-106 one or more objectives may include for example, receiving CUPRAS, receiving access to COAS, receiving services provided by a RELE 111.

The RELEA System 101 acts as a vehicle, such as an administrator system, to facilitate the exchange of information between RELEs 111 and RELE Customers 102-106. In addition, the RELEA System 101 may act as an exchange or other vehicle for the execution of RELE investment transaction. In some embodiments, an intermediary 112 such as a service provider or a marketing entity may facilitate Customer 102 access to a RELEA system 101. Embodiments may also include an Investment Entity 113, such as a broker dealer which serves to facilitate Customer 102 access to a RELEA system 101.

Qualifications descriptive of a RELE 111 may include, for example, a type of service provided by or on behalf of the RELE 111, one or more COASs provided by or on behalf of the RELE 111, one or more CUPRAS received based upon investment in a RELE 111.

The qualifications are preferably input as electronic data. However, informational data descriptive of one or more CUPRAS may include electronic records, electronic data files, hardcopy documents, oral interviews or other sources may also be received, scanned, transcribed or otherwise input into the RELEA System 101. Images of hard copy documents may be viewed or transmitted, such as by email, streamed, links to document repositories

In some embodiments, an Intermediary 112 may also be involved in brokering an investment in a Defined Set of Assets in a RELE 111. Intermediaries 112 may take many forms including a hedge fund, a bond broker, a payment service bureau, a website, a dealer, an agent, a retailer, an exchange, a financial advisor or an independent consultant. Typically, an intermediary 112 will present qualifications of a RELE 111 in a manner that addresses a Customer's 102 planned objectives. Planned objectives may include, by way of non-limiting example, investment objectives, and receipt of the benefits of a service offering or both.

The RELEA System 101 may store and organize RELE 111 qualifications as electronic data which may be presented to a RELE investor 102-106 to facilitate investment in a RELE 111. Presentation to the RELE investor 102-106 may include an offer with terms under which an Investor 102-106 may invest in a RELE 111. In some preferred embodiments, a RELE investor 102-106 may accept an offer for investment in a technology or any type of specified asset(s) for a particular RELE 111 or group of RELEs 111 and a technology contract may be executed with a digital signature or other electronic mechanism for creating a legally binding artifact. For example the legally binding artifact may define a relationship between entities and rights due to each entity. In some embodiments, a standardized instrument, such as a bond, contract or any electronic message that serves as proof of an agreed upon transaction between parties.

In order to facilitate the investment process, an investor may arrange for a pre-authorized line of credit. One credit arrangement may include a credit line collateralized by one or both of a CUPR a COAS or another asset. A collateralized line of credit allows success in a first RELE SPE investment to be used as collateral to allow the investor to invest in one or more additional RELE SPEs. Assets may also be leveraged with debt if desired. Other credit arrangements may include charging a line of credit, on online payment transfer account, electronic remittance, a credit card or debit card.

A RELE investor 102-106 may include an individual or institution that seeks a profitable return on investment and/or that seeks to receive one or more of a CUPRA, a COAS and a service associated with investment in a RELE 111.

In some embodiments, according to applicable laws and regulations, and perhaps according to a size of a RELE investment and/or the structure of the RELE investment, a RELE investor 102-106 may be required to be a qualified investor according to Securities Exchange Commission guidelines.

Return on an investment in a RELE 111 may be based upon a value of equity in the RELE 111 and/or a value of one or more of: a CUPRA, a COAS and a service associated with investment in a RELE 111.

In some embodiments, the computer model generated by the RELEA System 101, or other computer, may systematize analysis for multiple participants with various qualifications and backgrounds. Amongst other functions, analysis may include grouping multiple RELEs 111 together in order to create a hedge or otherwise diminish risk associated with investing solely in any one particular RELE investment. In one example, a group of RELEs with similar attributes may be formed into a portfolio, such as, for example, power utilities in several geographic or political areas. In this case, investment in the portfolio may reflect a particular market segment and yet be insulated from the peculiarities that may be associated with a specific RELE 111. Hedging may also be conducted across industries or sectors, according to technologies, across chosen learning institutions, amongst various market types or any other combination of factors. In addition, hedging may be utilized within a homogeneous group of RELEs 111, whereby risk is not associated so much with an individual RELE 111, but with a group of RELEs with similar attributes. Analysis of a hedged group may include expected return on investment, likelihood of success in achieving a particular goal, quantification of a particular need, or other inquiry.

Accordingly, RELEs may be grouped together to form a portfolio for investment, thereby forming an “industry fund” of investment opportunity in RELEs that provide one or both of a CUPRA and a COAS. A RELE 111 portfolio may be created to address various investment criteria, such as those listed above for analysis. For example, a RELE may be created to invest or promote a particular industry or service or asset without being limited to one RELE or a RELE may be created that includes multiple diverse services and assets to further diversify risk associated with a RELE.

Another embodiment of the present invention may include an alternative to a RELE wherein an investor may purchase or otherwise acquire an interest in an investment entity 124, such as a limited liability company (LLC). The investment entity 124 may be utilized to make one or more investments in one or more RELEs. If desired, the investment entity 124 may also be a single member investment entity 124 formed on behalf of the RELE investor 102-106. For the purposes of this invention, an LLC may be an unincorporated organization that provides limited liability to its members, regardless of the extent of their participation in the management of the LLC. Advantages of investing through an LLC may include protection for a RELE investor 102-106 as a member of the LLC. In their capacity as members of the LLC, the RELE investors may not be personally liable for the debts, obligations or liabilities of the LLC, except to the extent the members agree to be personally liable pursuant to an agreement and except that members may be obligated to repay any amounts wrongfully distributed to them. Absent an affirmative election to treat a single member LLC as an association taxable as a corporation, a single member LLC may presently be treated as a disregarded entity for federal income tax purposes (i.e., as a sole proprietorship if owned by an individual). Other legal organizations with similar or different advantages may also be utilized as an investment entity 124.

A RELEA system 101 may also act as a conduit for information and transactions between Customers 102-106, Intermediaries 112, Investment Entities 113 and a RELE 111. In some embodiments, a RELEA system 120 may include automated apparatus (as described further below) for processing data, including generating, receiving, and manipulating digital data. The RELEA system 120 may receive and respond to queries, generate reports, transmit data including responses to queries and reports, receive data on RELEs, generate projections related to RELEs, calculate and transmit financials, track RELE progress, track subject areas related to RELEs, and other related data processing.

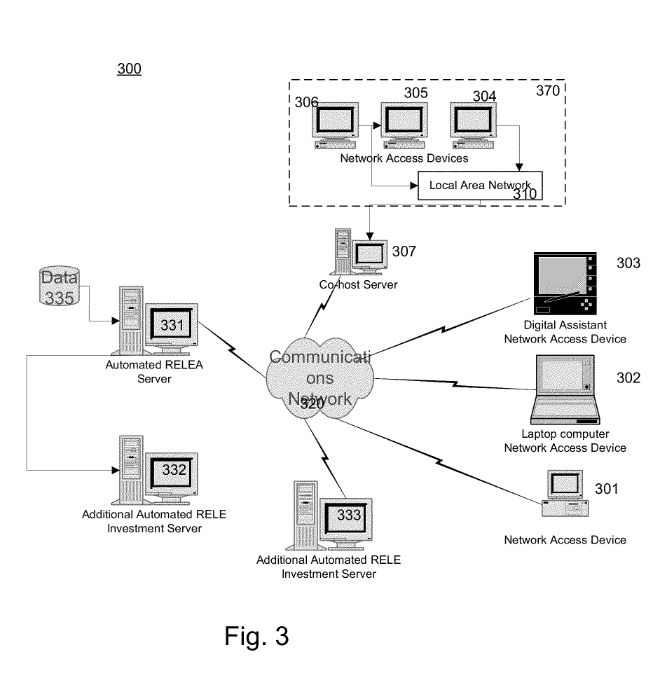

Referring now to FIG. 1B, a block diagram illustrates a relationship between one or more Customers 121 and an OPFA 122. For example, an OPFA may include a Power Generation Mutual or BioMed Mutual). The OPFA 122 includes one or more COASs and is associated with one or more CUPRAS 124. The OPFA 122 conveys rights to the Customer 121 based upon the Customer making a purchase from the OPFA 122 or the RELE 125 or other provision of value, such as cash, to the OPFA 122 or RELE 125. Actions and transactions between a Customer and a OPFA 122 or RELE 125 may be facilitated via one or more automated apparatus as discussed more fully below with regards to FIG. 3.

A Customer 121 may also purchase one or more CUPRAS 124. The CUPRAS 124 may be used in conjunction with one or more COAS 123 as the Customer 121 receives one or more services from the OPFA 122 or the RELE 125. In some embodiments, the CUPRAS 121 are necessary to receive a requested service. For example, in order to receive a service, such as electrical power, from a Power Generation Mutual, a Customer may need to own one or more CUPRAS, such as, by way of non-limiting examples, a transmission line, a power meter, a small power source (like a Photovoltaic array), an antenna, a down converter, a demarcation processor, etc. Pertaining to a BioMed Mutual 122 may include COASs 123 in the form of facilities to preserve genetic samples, blood, tissue, stem cells or other biologics. A CUPRA 121 may include one or more specific storage facilities.

Some products embodying the present invention may include a fractional share of a portfolio or basket of RELE contracts. For example, a portfolio of RELE contracts may be set up as unit investment trust, a closed end trust or an open end fund. In an open end fund the total amount of shares outstanding within the trust may fluctuate daily according to investment interest. Investment in an open end fund may be made available an exchange, such as for example via an ETF exchange.

Still other embodiments may include creating a corporation wherein corporate assets include specific RELE contracts. Shares in the corporation may be traded according to the value of the contracts held, the automated transfer apparatus 126 may contain customer data 121 that describes the CUPRAS 124 and COAS 123 that can be sold, conveyed or traded for consideration.

An electronic database of statistical information may be stored in a computer containing RELE investment statistics that are registered in the defined geographic area or other criteria based upon information included in a Customer CUPRA account. This database may include fund value for a given time period, portfolio composition, investment objective, load adjusted and unadjusted return, maximum sales charge, median market capitalization, daily, monthly, quarterly, yearly, multi-year returns, beta, sharpe, R squared, standard deviation, historical risk/reward ratios, distribution adjusted earning, payout ratio, potential capital gains exposure, price ratios, prospectus, purchase constraints, redemption fees, sector weighting, shareholder fees, total return, total return percentile, turnover ratio, deferred fees, manager name, manager tenure, class of shares, and brokerage availability. It will be understood that not all of this information is required to practice the claimed invention.

A computer program algorithm may be created responsive to a query by an interested party, such as a RELE investor 102-106, or fund manager. The algorithm may act as a filter eliminating from a search all RELE contracts that do not fit within the criteria and present a list of those RELE contracts that do meet the criteria or store those contracts within a new section of the computer memory. A time period (t) for which statistics will be analyzed may also be specified. In addition, a RELE contract or portfolio of contracts may be ranked based upon its performance over specific time periods.

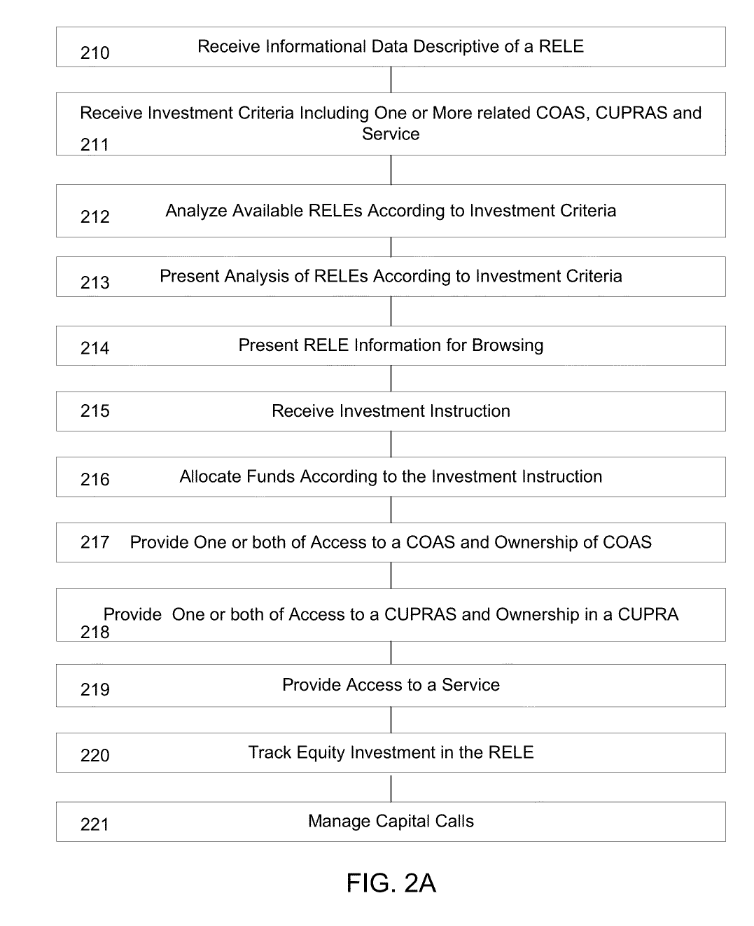

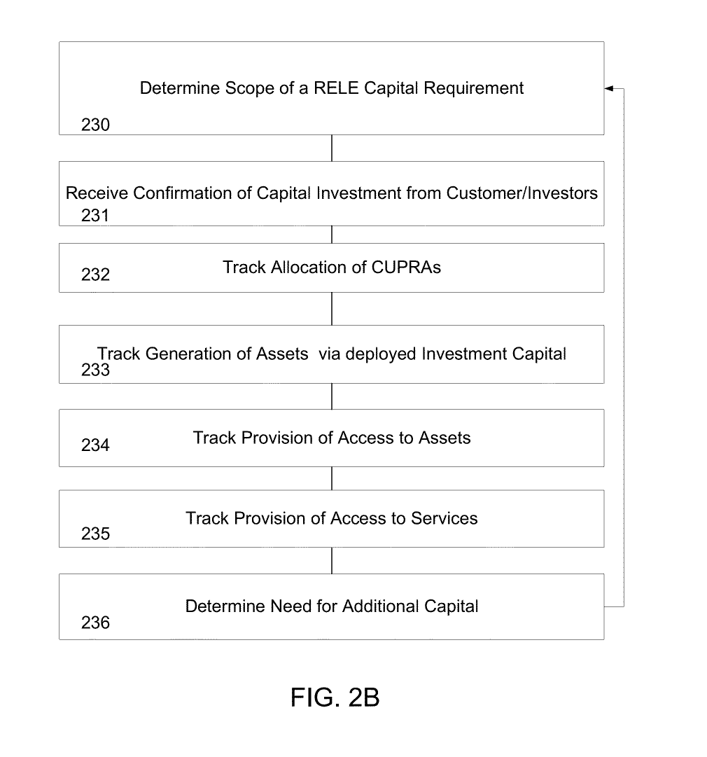

Referring now to FIG. 2A, a flow of exemplary computerized method steps that may be implemented according to the present invention is illustrated. The steps may be performed by an automated RELE investment system that provides for one or both of a COA and CUPRA to a Customer/Investor. At 210 the RELEA System 101 may receive informational data descriptive of a RELE and the RELE's qualifications. Information may be received as data that is input directly into the RELEA System 101 with a computer input device, such as a keyboard, pointing device, voice recognition or other device. In one example a graphical user interface (GUI) or application program interface (API) may be utilized to ease the data input. Data may also be received via an electronic communication, such as a data feed, e-mail, or RELE 111 submission. Typically the data will be received into structured fields in a database, however, data may also be received as unstructured information, such as in the form of an abstract, biographical or resume descriptive of a RELE 111.

RELE information may include any data descriptive of a RELE 111 that may be of interest to a potential RELE investor 102-106 or other interested party, such as, for example a technology facilitator 125. RELE information may include objective and/or subjective data, biographical information, demographic information, description of a RELE's accomplishments, class standing, political objectives, business objectives, academic objectives or other information relating to a RELE 111 and/or the RELE's 111 intended plans.

At 211, The RELEA System 101 may also receive investment criteria of a Customer/Investor. The investment criteria may include, for example, one or more assets such as a COAS or a CUPRA relating to an investment transaction. Presentation of the criteria to a RELE investor 102-106 may be accomplished via hardcopy or via an electronic interface, such as a graphical user interface.

At 212, The RELEA System 101 may analyze the RELE 111 information according to the investment criteria in order to determine those RELEs that meet the criteria set forth by a specific RELE investor 102-106.

At 213, results of the analysis according to investment criteria may be presented via a GUI, text document, printed report, electronic message, or other method.

Presentation of RELE analysis may be accomplished electronically via a model generated by the computerized RELEA System 101, through a hardcopy prospectus, or other communication media. In some embodiments, a graphical user interface (GUI) such as those further discussed below may be utilized to present the investment criteria 213 and RELE attributes.

Presented analysis may also include information specifying assets, including CUPRAS and COASs that will be provided based upon receipt of a threshold of investment.

If appropriate, a service provision model that details a service to be provided based upon an investment received may be generated by the RELEA System 101 and present how one or more assets may be used in conjunction with provided services.

At 214, in another embodiment, the RELEA System 101 may present RELE information for browsing. Browsing may also be accomplished, for example, through an electronic interface or via a printed document.

At 215, an instruction to invest in a RELE 111 may be received by the RELEA System 101. Typically, an investment instruction will be received from a RELE investor 102-106 that has been identified to the RELEA System 101. In some embodiments, credit limits and/or collateral arrangements have been previously arranged for an investor allowing the investor to openly engage in the buying and selling of RELEA and/or RELEA based ETF securities. However, in the event such payment arrangements have not been made, the RELEA System 101 may branch to an automated system for quantifying payment terms, or refer the RELE investor 102-106 to an account representative.

At 216, Funds may be allocated according to a RELEA investment instruction received. In those instances where it is required, approval for an instruction received may be accepted via a an electronic signature, login password, security token, or any other well-known method for identifying a user accessing a computer system that may be utilized to sufficiently associate an instruction with a particular RELE investor 102-106. In addition to other well-known methods, allocation may be accomplished via disbursement of funds via an instruction to a financial institution, or by transfer directly from RELE investor 102-106 to a RELE.

The RELEA System 101 may also track an ongoing RELE status including attributes, financial data or other information related to the RELE 111. Capital calls or other investment installments into an investment entity may be made contingent upon the attainment of interim or final goals set for the RELE 111 and may also be tracked by RELEA System 101. The attainment of interim or final goals may increase the value of a RELE investor's 102-106 position in a RELE 111. RELE investor 102-106 positions may be traded or otherwise transferred. Therefore interim goals may be key to a RELE investor 102-106 exit strategy.

An automated RELE investment provider 112 may also track activities relating to the management of a RELE 111 and/or portfolio and present relevant information on an ongoing basis.

At 217, in some embodiments, based upon an investment in a RELE, an investor maybe provided access to one or more COASs. In some preferred embodiments, the COAS may be maintained by the RELE and made available for access by the investor. In some embodiments a service may be provided to the investor in conjunction with the COAS. In addition, a Customer/Investor may be provided an ownership interest in the COAS.

At 218 in some embodiments, based upon an investment in a RELE, an investor maybe provided access to one or more CUPRAS may be made available to a Customer Investor. The Investor/Customer will be provided one or both of an ownership interest and a security interest in one or more CUPRAS. Typically, CUPRAS will be maintained by, or on behalf of the Investor/Customer.

At 219, in some embodiments, based upon an investment in a RELE, an investor maybe provided access to one or more services made available to a Customer/Investor.

At 220, in some embodiments, the RELEA may also track an equity investment in a RELE which may include a number of shares or Units in a RELE and/or a percentage of ownership in a RELE.

At 221 in some embodiments, the RELEA may also manage Customer Capital Calls. Embodiments may include participation in Customer Capital Calls in order for Investor/Customers to maintain their CUPRAS in a manner that allows then to properly work when there is an upgrade to the COAS

The RELEA System 101 may compare multiple RELE offerings to allow a RELE Investor 102-106 to make informed decisions concerning investment or holdings in RELEs and access to CUPRAS, COASs and services provided by a RELE.

Referring now to FIG. 2B, method steps that may be implemented by an automated apparatus are illustrated. At step 230, the automated apparatus may receive in data descriptive of a capital requirement of a RELE and related to a purpose of a RELE and services and assets to be deployed by the RELE. Factors such as scaling up hardware to support planned growth, geographic location, real property available, capital equipment age and condition and upgrades may all be input into an automated apparatus for calculation of a RELE Capital Requirement.

At step 231, the apparatus may receive confirmation of capital investment from one or more Customer/Investors. At 232, the apparatus may track allocation of CUPRAS and at 233 track generation of assets through the deployment of investment capital.

At step 234, the apparatus may track provision of Customer/Investor access to assets based upon investment in an associated RELE. Assets may include one or both of a COAS and a CUPRA.

At step 235, the apparatus may track provision of Customer/Investor access to one or more services provided based upon investment in the RELE.

At step 236, the apparatus may determine a need for additional capital for the RELE to meet the needs of the COAS. Additional capital may be related to one or both of: growth of the RELE and ongoing access to assets and services. If additional capital is required, the process may repeat itself.

FIG. 3 shows a network of computers 300 that may be used in an implementation of an automated apparatus for administering a RELE. The network 300 includes an automated RELEA server 331 or other host system and client computers 301-306. Each of the client computers may include a processor, memory, a user input device, such as a keyboard and/or mouse, and a user output device, such as a video display and/or printer. The client computers 301-306 may communicate with the technology server 331 to obtain data stored at the technology server 331.

A client computer 301-306 may interact with the RELEA System's Server 331 as if the RELEA Server 331 was a single entity in the network 300. However, the RELEA Server 331 may include multiple processing and database sub-systems, such as cooperative or redundant processing and/or database servers 341-344, that may be geographically dispersed throughout the network 300. In addition, there may be more than one occurrence of a host server 332. In some implementations, groups of client computers 304-306 may communicate with technology server 331 through a local server 307. The local server 307 may be a proxy server or a caching server. Server 307 may also be a co-host server that may provide services in conjunction with assets.

The RELEA Server 331 includes one or more databases 345 which may store data relating to assets, services and Customer/Investors.

A user may access the RELEA Server 331 using client software executed at the user's network access device 301-306. The client software may include a generic hypertext markup language (HTML) browser, such as Google Chrome, Firefox, Safari, Opera or Microsoft Internet Explorer, (a “WEB browser”). The client software may also be a proprietary browser, and/or other host access software. In some cases, an executable program, such as a Java™ program, may be downloaded from the technology server 331 to the client computer and executed at the client computer.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. Preferably the invention will be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Automated apparatus included in, or connected to in an automated RELE system 300 may be connected to each other by one or more network interconnection technologies. For example WiFi networks, data lines and cellular networks. Functions associated with separate processing and database servers in the RELEA server 331 may be integrated into a single server system or may be partitioned among servers and database systems that are distributed over a wide geographic area.

By way of non-limiting example, client computers 301-307 may comprise a personal computer executing an operating system such as Microsoft Windows™, UNIX™, Linux or an Apple operating system, as well as software applications, such as a web browser. Client computers 301-303 may also be terminal devices, or a mobile phone WEB access device, a tablet that adheres to a point-to-point or network communication protocol such as the Internet protocol. Other examples may include TV WEB browsers, terminals and wireless access devices (such as an Android device). A client computer or other Web Access Device may include a processor, RAM and/or ROM memory, a display capability, an input device and hard disk or other relatively permanent storage. Interactive graphical user interfaces specifically related to information generated as a result of the workings of the financial structuring system may include any information contained within databases relating to the financial structure, or derivative of such information.

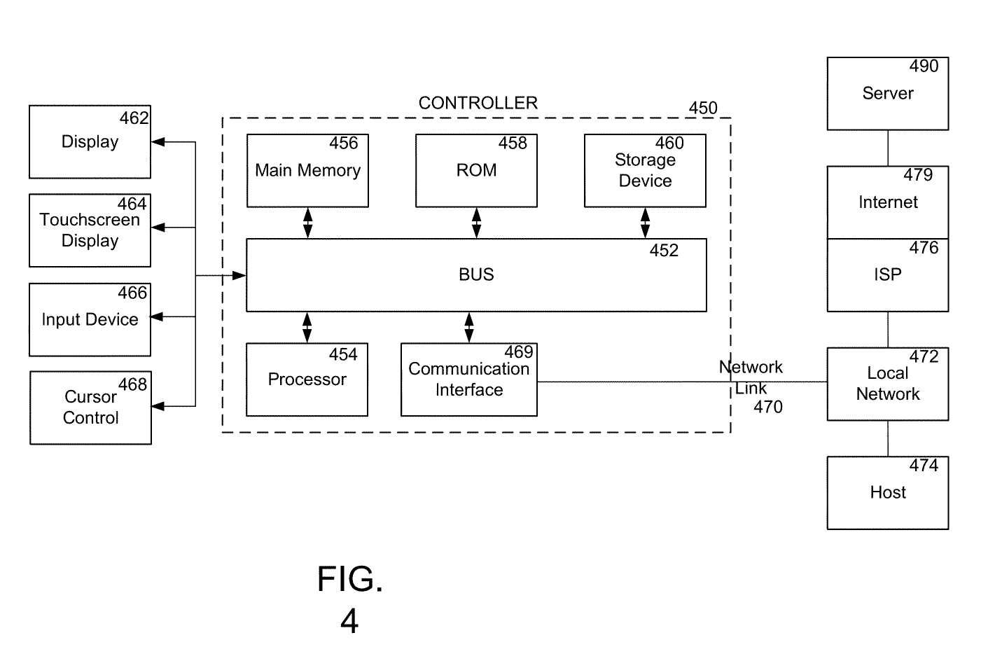

Referring now to FIG. 4, additional aspects of controller hardware which may be included as computer hardware, useful for implementing the present invention may be illustrated as a block diagram that may include a controller 450 upon which an embodiment of the invention may be implemented. Controller 450 may include a bus 452 or other communication mechanism for communicating information, and a processor 454 coupled with bus 452 for processing information.

Controller 450 may also include a main memory 456, such as a random access memory (RAM) or other dynamic storage device, coupled to bus 452 for storing information and instructions to be executed by processor 454. Main memory 456 may also be used for storing temporary variables or other intermediate information during execution of instructions to be executed by processor 454. Controller 450 may further include a read only memory (ROM) 458 or other static storage device 460.

Controller 450 may be coupled via bus 452 to a display 462, such as a liquid crystal display (LCD), for displaying information to a computer user. An input device 464, including alphanumeric and other keys, or modes of input, such as, for example, a microphone and a radio frequency device such as Bluetooth, may be coupled to bus 452 for communicating information and command selections to processor 454. Another type of user input device may be a cursor control 466, such as a mouse, a trackball, a touchpad, touchscreen, or cursor direction keys for communicating direction information and command selections to processor 454 and for controlling cursor movement on display 462. This input device may typically have two or three degrees of freedom in two axes, a first axis (e.g., x) and a second axis (e.g., y), that allows the device to specify positions in a plane or stereo cameras that process and provide a third axis of input.

Some embodiments of the invention may be related to the use of controller 450 for setting operational parameters. According to one embodiment of the invention, control parameters may be defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein may refer to any medium that participates in providing instructions to processor 454 for execution. Such a medium may take many forms, including but not limited to, non-volatile media, volatile media, and transmission media. Non-volatile media includes, for example, solid state devices (SSD) or magnetic disks, such as storage device 460. Volatile media may include dynamic memory, such as main memory 456. Transmission media includes coaxial cables, copper wire and fiber optics, including the wires that comprise bus 452. Transmission media may also take the form of infrared and radio frequency transmissions, acoustic or light waves, such as those generated during radio wave and infrared data communications.

Common forms of computer-readable media may include, for example, a memory stick, hard disk or any other magnetic medium, an optical medium, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 454 for execution. For example, the instructions may initially be carried on a magnetic disk of a remote computer. The remote computer can load the instructions into its dynamic memory and send the instructions over a distributed network such as the Internet. A communication device may receive the data on the telephone line and use an infrared transmitter to convert the data to an infrared signal. An infrared detector may receive the data carried in the infrared signal and appropriate circuitry can place the data on bus 452. Bus 452 may carry the data, or otherwise be in logical communication to the main memory 456, from which processor 454 retrieves and executes the instructions. The instructions received by main memory 456 may optionally be stored on storage device 460 either before or after execution by processor 454.

Controller 450 may also include a communication interface 469 coupled to bus 452. Communication interface 469 provides a two-way data communication coupling to a network link 470 that may be connected to a local network 472. For example, communication interface 469 may operate according to the internet protocol. As another example, communication interface 469 may be a local area network (LAN) card a data communication connection to a compatible LAN.

Network link 470 may typically provide data communication through one or more networks to other data devices. For example, network link 470 may provide a connection through local network 472 to a host computer 474 or to data equipment operated by an Internet Service Provider (ISP) 476. A wireless links may also be implemented. ISP 476 in turn may provide data communication services through the worldwide packet data communication network now commonly referred to as the “Internet” 479. Local network 472 and Internet 479 may both use electrical, electromagnetic or optical signals that carry digital data streams. The signals may be transmitted through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. Some exemplary controllers 450 may include a personal digital assistant, a mobile phone, a smart phone, a tablet, a netbook, a notebook computer, a laptop computer, a terminal, a kiosk or other type of automated apparatus. Additional exemplary devices may include any device with a processor executing programmable commands to accomplish the steps described herein.

A controller may include one or more of: personal computers, laptops, pad devices, mobile phone devices and workstations located locally or at remote locations, but in communication with the controller. System apparatus may include digital electronic circuitry included within computer hardware, firmware, software, or in combinations thereof. Additionally, aspects of the invention may be implemented manually.

Apparatus of the invention may be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object oriented programming language, or in assembly or machine language if desired, and in any case, the language can be a compiled or interpreted language. Suitable processors may include, by way of example, both general and special purpose microprocessors.

Generally, a processor may receive instructions and data from a read-only memory and/or a random access memory. Generally, a computer may include one or more mass storage devices for storing data files; such devices include Solid State Disk (SSD), magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks may be included. Any of the foregoing may be supplemented by, or incorporated in, ASICs (application-specific integrated circuits).

In some embodiments, implementation of the features of the present invention may be accomplished via digital computer utilizing uniquely defined controlling logic, wherein the controller includes an integrated network between and among the various participants in Process Instruments.

The specific hardware configuration used may not be particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the controller. These selections may be set according to per se well-known conventions in the software community.

The present invention is described herein with reference to block diagrams and functional illustrations of methods and apparatus to implement various aspects of the present invention. It is understood that each block of the block diagrams or operational illustration or function represented, and combinations of blocks in the block diagrams or operational or functional illustrations, may be implemented by automated apparatus, such as analog or digital hardware and computer program instructions. These computer program instructions may be provided to a processor of a general purpose computer, special purpose computer, cellular device, smart device, ASIC, or other programmable data processing apparatus, such that the instructions, which execute via the processor of the computer or other programmable data processing apparatus, implements the functions/acts specified in the block diagrams or operational block or blocks. In some implementations, the functions or method steps described in relation to the blocks or functional representations may occur in an order other than the order noted or described herein, For example, blocks or functional representations shown in a succession may be executed substantially concurrently or the blocks in an alternate order, depending upon a specific implementation of the present invention. It is therefore understood that unless otherwise specifically noted and thereby limited, the discussion here is presented in an order to facilitate enablement and understanding and is not meant to limit the invention disclosed.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

What is claimed is:

1) An automated apparatus for managing ownership interest in assets, the method comprising:
a storage medium comprising descriptions of one or more allocable assets comprising Customer Proprietary Assets and Commonly Owned Assets;
a computer server accessible with a network access device via a digital communications network; and
executable software stored on the server and executable on demand, the software operative with the server to cause the apparatus to:
generate investment criteria relating to a hybrid asset backed security for a recognized legal entity, wherein the hybrid asset backed security comprises rights to one or both of: the Customer Proprietary Assets and rights to access the Commonly Owned Assets associated with the recognized legal entity;
transmit the investment criteria across the digital communications network to a network access device associated with a Person capable of making an investment;
receive an investment instruction from the network access device to make an investment in the legal entity according to the investment criteria; and
generate a transaction based upon to the investment instruction received, whereby the transaction transfers an ownership interest in the legal entity and one or more assets to the investor.

2) The apparatus of claim 1 wherein the software is additionally operative with the server to cause the apparatus to model an expected return on investment based upon acquisition of the hybrid asset backed security.

3) The apparatus of claim 1 wherein the software is additionally operative with the server to cause the apparatus to generate an entitlement to a service commensurate with the amount of investment made in the hybrid asset backed security.

4) The apparatus of claim 3 wherein the software is additionally operative with the server to cause the apparatus to monitor the provision of the service.

5) The apparatus of claim 1 wherein the Person capable of making an investment comprises one or more of: a Customer, a Subscriber, a Shareholder, and a participant.

6) The apparatus of claim 5 the software is additionally operative with the server to cause the apparatus to transfer ownership in Commonly Owned Asset owned according to an ownership interest in a RELE and available for use by two or more Customers.

7) The apparatus of claim 6 the software is additionally operative with the server to cause the apparatus to transfer ownership in a Customer Proprietary Asset owned an asset owned by a Customer that may be used in conjunction with Services provided by a legal entity.

8) The apparatus of claim 5 wherein the software is additionally operative with the server to cause the apparatus to generate terms of a Customer Capital Call based upon capital needs to upgrade the one or more Commonly Owned Assets.

9) The apparatus of claim 8 wherein the wherein the software is additionally operative with the server to cause the apparatus to receive a transmission authorizing participation in the Customer Capital Call by the investor.

10) The apparatus of claim 8 wherein participation in the Customer Capital Call additionally maintains the ability of a CUstomer PRoprietary ASset to function with a provided service.

11) The apparatus of claim 8 wherein participation in the Customer Capital Call additionally maintains the ability of a CUstomer PRoprietary ASset to function with a provided service and in conjunction with one or more Commonly Owned Assets.

12) The apparatus of claim 1 wherein investment is made on behalf of an underlying investment vehicle.

13) The apparatus of claim 12 additionally comprising tracking a membership interest in the underlying investment vehicle commensurate with a capital contribution to the underlying investment vehicle.
